(19) United States
(12) Patent Application Publication
(10) Pub. No.: US 2008/0144922 A1
(43) Pub. Date: Jun. 19, 2008

(54) PATTERN ALIGNMENT METHOD, PATTERN INSPECTION APPARATUS, AND PATTERN INSPECTION SYSTEM

(75) Inventor: Hiroshi Naiki, Ina-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION, Tokyo (JP)

(21) Appl. No.: 11/939,653

(22) Filed: Nov. 14, 2007

(30) Foreign Application Priority Data
Nov. 16, 2006 (JP) P2006-310201

(51) Int. Cl. G06K 9/00

(52) U.S. Cl. 382/145

(57) ABSTRACT

The present invention relates to a pattern inspection apparatus that allows alignment of various patterns formed on a subject specimen to quickly and easily be performed in a manufacturing apparatus or inspection apparatus of a subject specimen such as a wafer. The pattern inspection apparatus of the present invention includes a specimen alignment device and a displacement amount calculation device. The specimen alignment device places a plate-shaped subject specimen T in a position in which shapes of outer circumferential sections T1 and T3 of the subject specimen T are substantially aligned with shapes of outer circumferential sections R1 and R3 of a plate-shaped reference specimen R relative to each other, the shapes of the reference specimen R being similar to the shapes of the subject specimen T. The displacement amount calculation device calculates a displacement amount between the position of a subject pattern T5 formed on the subject specimen T and the position of a reference pattern R5 formed on the reference specimen R while the shapes of the outer circumferential sections T1 and T3 of the subject specimen T are respectively aligned with the shapes of the outer circumferential sections R1 and R3 of the reference specimen R.

### BACKGROUND OF THE INVENTION

1. Field of the Invention

The present invention relates to a pattern positioning method, a pattern inspection apparatus, and a pattern inspection system.

Priority is claimed on Japanese Patent Application No. 2006-310201, filed in Japan on Nov. 16, 2006, the contents of which are incorporated herein by reference.

2. Description of Related Art

In a manufacturing process for semiconductor wafers, it is necessary to position a higher layer over a lower layer with a high level of accuracy while sequentially laminating a plurality of layers on which a circuit pattern is formed to perform exposure.

Conventionally, the position of an alignment mark formed on a part of a layer is visible in every layer by a microscope with a high magnification, and an alignment mark formed on an upper layer is matched with an alignment mark formed on a lower layer to achieve positioning with a high level of accuracy. Operations for detecting a displacement between the two alignment marks and operations for superimposing these alignment marks are automatically performed by various detection apparatuses, transfer apparatuses, and the like.

In the preprocess of semiconductor manufacturing, an alignment mark that serves as a reference for alignment is not formed when a circuit pattern is formed on a semiconductor wafer for the first time. Therefore, an orientation flat (hereinafter, referred to as OF) or a notch that serves as an alignment reference is used to perform alignment, and a circuit pattern is exposed once the wafers are aligned.

Moreover, an alignment mark that shows a crystal azimuth is exposed and formed in the first exposure step, and circuit patterns are exposed with reference to the alignment mark in the subsequent step for exposing circuit patterns (for example, see Japanese Unexamined Patent Publication, First Publication No. H09-74062).

### SUMMARY OF THE INVENTION

An object of the present invention is to provide a pattern alignment method and pattern inspection apparatus that are capable of quickly and easily positioning various patterns, such as a circuit pattern and an alignment mark formed on a wafer, and providing a pattern inspection system.

To achieve the above-mentioned object, the present invention provides a pattern inspection apparatus including a specimen alignment portion and a displacement amount calculation portion. The specimen alignment portion places a plate-shaped subject specimen in a position where the shape of the outer circumferential sections of the subject specimen substantially matched the shapes of the outer circumferential sections of a plate-shaped reference specimen, the shapes of the reference specimen being similar to the shapes of the subject specimen. The displacement amount calculation portion calculates a displacement amount between the position of a subject pattern formed on the subject specimen and the position of a reference pattern formed on the reference specimen while the shapes of the outer circumferential sections of the subject specimen are aligned with the shapes of the outer circumferential sections of the reference specimen.

### BRIEF DESCRIPTION OF THE DRAWINGS

FIG. 1 is a block diagram showing a schematic construction of a macro inspection apparatus according to one embodiment of the present invention.

FIG. 2 is a schematic planar view showing a semiconductor wafer which is macro inspected in the macro inspection apparatus of FIG. 1.

FIG. 3 shows a reference image that is previously registered in advance in the macro inspection apparatus of FIG. 1.

FIG. 4 shows a positional relationship between a reference image and a subject image that is obtained by an imaging portion of the macro inspection apparatus of FIG. 1.

FIG. 5 is a flow chart explaining an operation of the macro inspection apparatus of FIG. 1.

FIG. 6 is a schematic planar view showing how a semiconductor wafer is positioned in a specimen alignment portion of a macro inspection apparatus according to another embodiment of the present invention.

FIG. 7 is a block diagram showing a schematic construction of a defect inspection system according to another embodiment of the present invention.

### DETAILED DESCRIPTION OF THE INVENTION

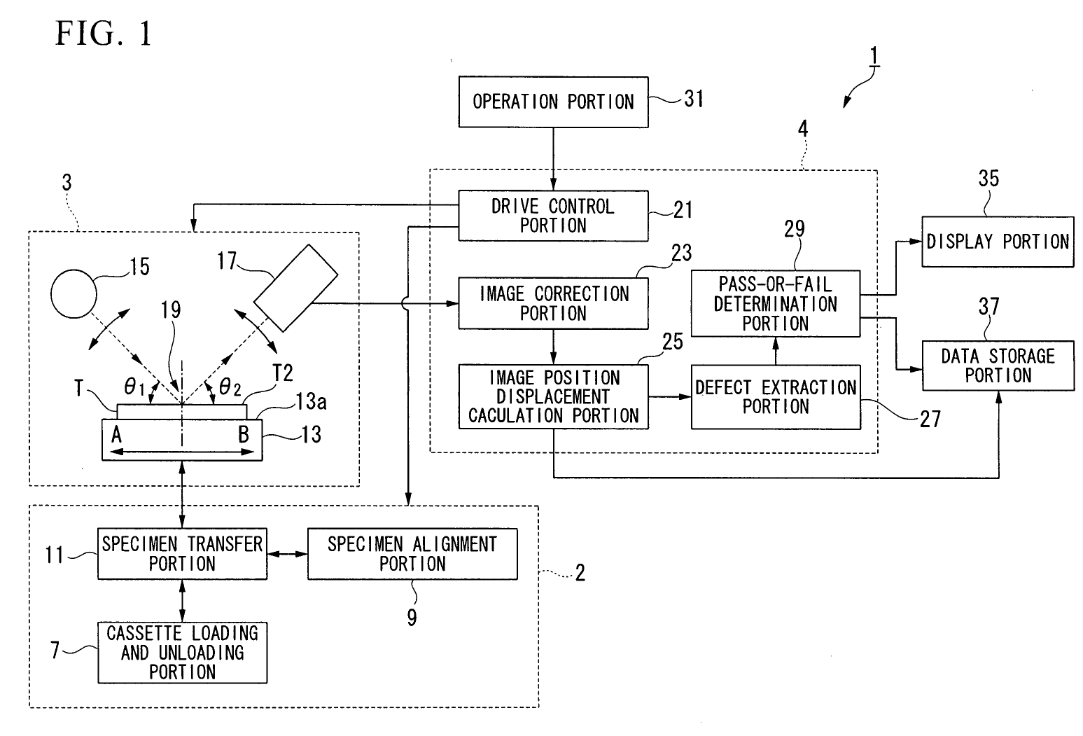

FIGS. 1 through 5 show one embodiment according to the present invention. The embodiment described here is a case in which the present invention is applied as a semiconductor manufacturing processing apparatus to a macro inspection apparatus for performing a macro inspection after the development step in the photolithography process. This macro inspection apparatus is one that determines whether or not a circuit pattern formed on a predetermined region of a layer has a defect.

As shown in FIG. 1, a macro inspection apparatus (a pattern inspection apparatus) 1 includes: a transfer portion 2 for transferring a semiconductor wafer T as a subject specimen; an inspection portion (an image capturing device) 3 for macro inspecting the semiconductor wafer T; and an apparatus control portion 4 for controlling the transfer portion 2 and the inspection portion 3.

The transfer portion 2 includes: a cassette loading and unloading portion 7; a specimen alignment portion (a specimen alignment device) 9; and a specimen transfer portion 11.

The cassette loading and unloading portion 7 conveys a cassette, in which semiconductor wafers T to be macro inspected are stored, to/from the transfer portion 2 of the macro inspection apparatus 1.

The specimen alignment portion 9 performs positioning (prealignment) of a rotational position and center position of the semiconductor wafer T before the semiconductor wafer T that has been taken from the inside of the cassette by the specimen transfer portion 11 is carried in to the inspection portion 3. To perform positioning of the rotational position, a rotation table (a rotation stage) on which the semiconductor wafer T is mounted is rotated, and the rotational orientation of a characteristic section which is a linear-shaped OF (or notch) formed on the outer circumference of the semiconductor wafer T is detected by a position sensor. The rotation of the rotation table is then adjusted so that this characteristic section is oriented at a previously-established reference angle, thereby rotating the semiconductor wafer T into position (prealignment).

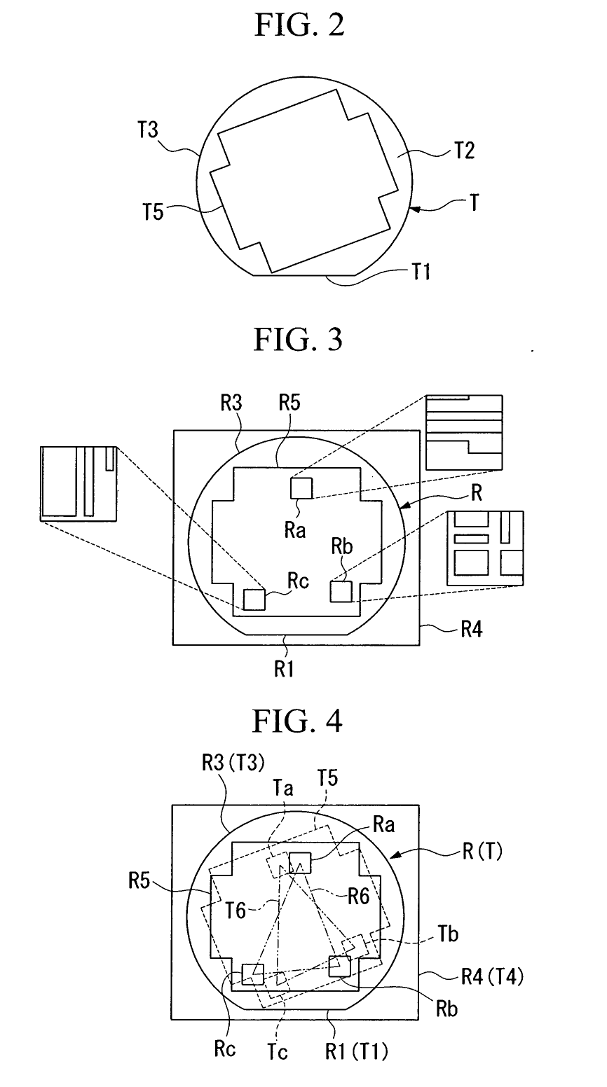

To perform alignment of the center position, at least two edge positions on a curve section T3 (see FIG. 2) of the outer circumference except the aforementioned characteristic section are detected by a position sensor to acquire a center displacement amount from the reference center position. The movement of the rotation table is then controlled in the XY direction so that the center of the semiconductor wafer T is aligned with the reference center position, thereby centering the semiconductor wafer T.

As shown in FIG. 1, the specimen transfer portion 11 transfers the semiconductor wafer T to and from the cassette loading and unloading portion 7, the specimen alignment portion 9, and the inspection portion 3. This specimen transfer portion 11 takes the semiconductor wafer T from the inside of the cassette of the cassette loading and unloading portion 7 to transfer it to the specimen alignment portion 9, and receives the semiconductor wafer T that has been positioned in this specimen alignment portion 9 to carry it into a specimen holding portion 13 of the inspection portion 3. The specimen transfer portion 11 mounts the semiconductor wafer T that has been aligned in the specimen alignment portion 9 so as to be fitted in the reference position on the specimen holding portion 13.

As this specimen transfer portion 11, a transfer robot with a multi-segmented articulated robotic arm can be used, which is provided with a hand and arm mechanism that holds the backside of the semiconductor wafer T by suction-clamping when the semiconductor wafer T is transferred or a hand and arm mechanism that grips and holds an outer edge of the semiconductor wafer T.

When the multi-segmented robotic arm of a type that grabs the outer edge of the semiconductor wafer T is used as the specimen transfer portion 11, only the rotational position of the OF T1 may be controlled in the specimen alignment portion 9 because the center position of the semiconductor wafer T is determined by holding the edge being held by the robotic arm.

The inspection portion 3 includes: a specimen holding portion 13 as a stage on which the semiconductor wafer T is mounted; an illumination portion 15; and an imaging portion 17.

The specimen holding portion 13 is configured so as to hold substantially the entire surface of the semiconductor wafer T by suction-clamping so that the semiconductor wafer T is mounted on an upper surface 13a thereof. Moreover, this specimen holding portion 13 is reciprocally movable in one axis line direction (the AB direction) along a surface T2 of the semiconductor wafer T.

The illumination portion 15 irradiates thin, linear-shaped (slit-shaped) light onto the surface T2 of the semiconductor wafer T mounted on the specimen holding portion 13. Moreover, this illumination portion 15 is movable along an arc whose center is an irradiation position 19 so that an incident angle of light θ1 with respect to the surface T2 of the semiconductor wafer T can be changed without moving the irradiation position 19.

The imaging portion 17 takes in the light reflected at the irradiation position 19 of the surface T2 of the semiconductor wafer T to transform it into an image. As this imaging portion 17, a line sensor camera or an area sensor camera may be used. In the present embodiment, a line sensor camera is used. Moreover, in order to capture an image of reflected light at a reflection angle θ2 from the irradiation position 19, this imaging portion 17 is movable along an arc whose center is the irradiation position 19 to modify an angle of the optical axis.

In this inspection portion 3, the specimen holding portion 13 moves in the A direction or B direction which is orthogonal to the linear irradiation position 19 to allow the irradiation portion 15 to scan and illuminate the entirety of the surface T2 of the semiconductor wafer T. Thereby, an image of the entire surface T2 of the semiconductor wafer T can be captured by the imaging portion 17. Therefore, the specimen holding portion 13 is made to move at a constant speed synchronous with a frequency for the imaging portion 17 to capture the image.

By appropriately adjusting one or both of the optical axis angle of the illumination portion 15 and that of the imaging portion 17, it is possible, for example, to take in optional n-th diffracted light reflected on the surface T2 of the semiconductor wafer T to obtain a diffraction image. Furthermore, by inserting an interference filter in the optical path to set the optical axis of the illumination portion 15 and that of the imaging portion 17 equal to each other with respect to the surface T2 of the semiconductor wafer T, it is possible to capture an interference image. Such a diffraction image or interference image is treated in an apparatus control portion 4 as a subject image for making a macro inspection of the semiconductor wafer T. When a circuit pattern without a defect is obtained as a result of a macro scan, such diffraction image or interference image is registered as a reference image in a pass-or-fail determination portion 29 of the apparatus control portion 4.

As shown in FIG. 1, the apparatus control portion 4 includes: a drive control portion 21; an image correction portion 23; an image position displacement calculation portion (an image calculation device) 25; a defect extraction portion (a defect extraction device) 27; and a pass-or-fail determination portion 29. The drive control portion 21 controls mechanical drive portions of the transfer portion 2 and the inspection portion 3. The image correction portion 23 subjects a subject image that is sent from the imaging portion 17 to a luminance correction such as a shading correction; a distortion correction; or a magnification correction. The distortion correction and the magnification correction mean correction of an image distortion and magnification by image processing. The corrected objects include, for example magnification differences of individual lenses provided in the imaging portion 17 and the illumination portion 15, and an adjustment error in the optical system made of the imaging portion 17 and the illumination portion 15.

The image position displacement calculation portion 25 calculates the amount of relative difference between the position of a circuit pattern displayed in the subject image that is outputted from the image correction portion 23 (hereinafter, referred to as a subject pattern) and the position of a circuit pattern displayed in a reference image that has been previously registered (hereinafter, referred to as reference pattern). The reference pattern is obtained by capturing an image of an entire surface of an OF (outer circumferential section) R1, which serves as a reference for alignment of a semiconductor wafer R as a reference specimen, in a state of being aligned in the reference position. A reference pattern R5 that is firstly transferred onto a semiconductor wafer R is horizontally transferred so as to be in a predetermined positional relationship with respect to the OF R1 as the reference surface (see FIG. 3).

That is, as shown in FIG. 3, in the image position displacement calculation portion 25, a plurality (three, in the example shown in the figure) of reference model regions Ra to Rc with a characteristic shape in the area of a reference pattern R5 of the semiconductor wafer R displayed in a reference image R4 are previously selected and extracted and, for example, center coordinates are acquired as coordinates for specifying the respective positions of the reference model regions Ra to Rc. Each of these reference model regions (search models) Ra to Rc is a characteristic pattern that is cut out from the reference image R4 and is made of a sum of the vertical number of pixels and the horizontal number of pixels ((the vertical number of pixels)×(the horizontal number of pixels)). Then, as shown in FIG. 4, a plurality (three, in the example shown in the figure) of subject model regions (search models) Ta to Tc that are respectively the most similar to the reference model regions Ra to Rc are extracted from the area of a subject pattern T5 displayed in a subject image T4.

The extraction of the subject model regions Ta to Tc is performed in the following manner. First, the positions in the subject image T4 which correspond to those of the reference model regions Ra to Rc are searched along with the surrounding areas thereof, to thereby acquire the rectangular regions which are respectively the most similar to the pattern shapes of the reference model regions Ra to Rc as the subject model regions Ta to Tc. At the same time, as coordinates for specifying their positions, for example respective center coordinates of the subject model regions Ta to Tc, are acquired.

Respective differences between the center coordinates of the reference model regions Ra to Rc and the center coordinates of the subject model regions Ta to Tc are calculated to acquire a displacement amount of the subject pattern T5 with respect to the reference pattern R5.

To be more specific, the center positional displacement amount of the subject pattern T5 with the OF T1 as the reference position is acquired from the rotational displacement amount of the subject pattern T5 formed by an angular difference between the orientation of a triangle T6 whose vertices are the center coordinates (that is, center positions) of the plurality of subject model regions Ta to Tc and the orientation of a reference triangle R6 whose vertices are the center coordinates (that is, center positions) of the plurality of reference model regions Ra to Rc.

As described above, the positions of the outer circumferential sections T1, T3 and R1, R3 of the semiconductor wafers T, R in the subject image T4 and the reference image R4 align each other. Therefore, it follows that the displacement amount of the subject pattern T5 is corrected with reference to the position of the OF T1. Furthermore, this displacement amount can be calculated by the pixel in the subject image T4 or the reference image R4.

The defect extraction portion 27 performs a transformation in which the subject pattern T5 is matched with the reference pattern R5 by using the displacement amount acquired in the image position displacement calculation portion 25 as a correction value. Moreover, the defect extraction portion 27 compares the subject image T4 with the reference image R4 pixel by pixel and recognizes defect pixels where a difference in the amount of characteristics such as luminance and the edge between pixels of the subject image T4 (a predetermined region) and pixels of the reference image R4 that correspond to the former pixels (a corresponding region) is larger than the preset threshold value.

The pass-or-fail determination portion 29 compares defect information data of the semiconductor wafer T as a subject specimen which is outputted from the defect extraction portion 27 with the previously-established pass-or-fail determination criteria and outputs the pass-or-fail determination result as a macro inspection result.

Furthermore, as shown in FIG. 1, this macro inspection apparatus 1 includes an operation portion 31, a display portion 35, and a data storage portion (storage device) 37 that are connected to the apparatus control portion 4 via interfaces (not shown in the figure).

The operation portion 31 is used by an operator to input various commands to the macro inspection apparatus 1, such as an inspection start command and a command for selecting the type of semiconductor wafer. Specific input devices for this operation portion 31 include, for example, a keyboard, a mouse, a trackball, and a touchscreen.

The display portion 35 is used by the operator to visually check the macro inspection result outputted from the pass-or-fail determination portion 29. Specific possible display contents include a corrected image, a defect superimposed image in which a defect image is superimposed over a corrected image with different colors for both images, the size of the defects, the number of the defects, the names of the defects, the center coordinates of the defects, the pattern displacement amount, the result of a pass-or-fail determination of the specimen, the type name of the semiconductor wafer T, the name of the manufacturing step, the lot ID for the semiconductor, the wafer ID and, the slot number (the number allocated to each shelf of the cassette for storing wafers). At least one or more of these display contents are configured to be simultaneously displayed on a screen of the display portion 35.

The data storage portion 37 is made of a storage medium such as a hard disk drive (hereinafter, referred to as HDD). Data to be stored in this data storage portion 37 includes data of the reference image R4, data of the macro inspection result, data of information on the displacement amount, a defected image in which defected pixels and other pixels are binarized, and a file of inspection result information. In the file containing inspection result information, there is collected information in which a pass-or-fail determination result of every chip of the semiconductor wafer T is added to at least any one piece of the above-mentioned storage data.

Next is a description of an operation of the macro inspection apparatus 1 that is constructed as above.

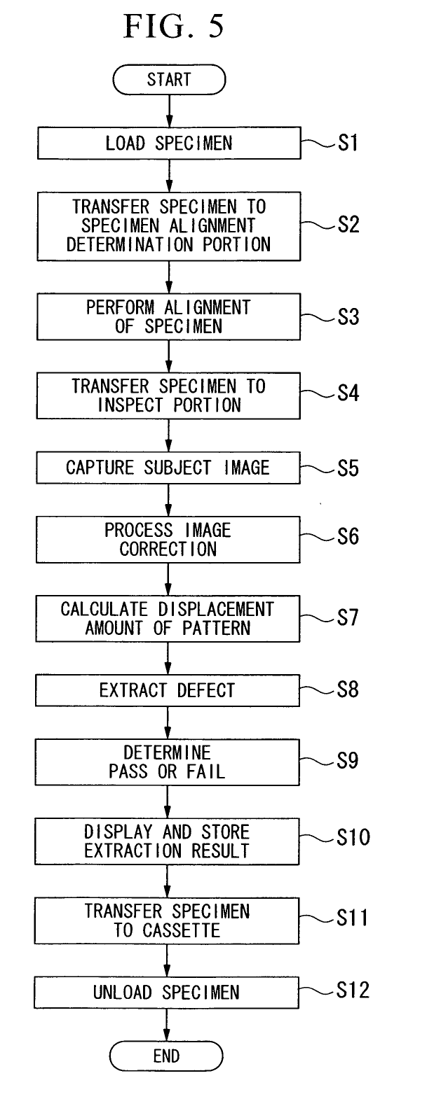

When the operator inputs an inspection start command in the operation portion 31, the drive control portion 21 gives the inspection start command to the individual drive portions of the drive control portion 21 and the inspection portion 3, and the processing shown in FIG. 5 is performed.

First, the cassette that contains semiconductor wafers T is loaded into the inside of the transfer portion 2 of the macro inspection apparatus 1 by the cassette loading and unloading portion 7 (Step S1). One semiconductor wafer T is taken out of the loaded cassette and is then transferred to the specimen alignment portion 9 by the specimen transfer portion 11 (Step S2).

Next, in the specimen alignment portion 9, the characteristic section (OF or notch) T1 on the outer circumference of the semiconductor wafer T and the curve section (outer circumferential section) T3 thereon are detected to perform a first positioning (prealignment) of the semiconductor wafer T in the preset reference position (Step S3).

The semiconductor wafer T that has been positioned (prealigned) in the specimen alignment portion 9 is transferred to the specimen holding portion 13 of the inspection portion 3 by the specimen transfer portion 11 (Step S4), and is then mounted on an upper surface 13a of the specimen holding portion 13. At this time, the semiconductor wafer T, is mounted on the reference position on the upper surface 13a by the specimen transfer portion 11 while being positioned, and is also attracted to the upper surface 13a to be integrally fixed to the specimen holding portion 13.

Subsequently, the specimen holding portion 13 is moved in the A or B direction at a constant preset speed so that the entirety of the semiconductor wafer T passes through the light irradiation position 19. In this movement, the reflected light from the irradiation position 19 is incident into the imaging portion 17, and the subject image T4 that has been captured in the imaging portion 17 is sent to the image correction portion 23 (Step S5).

The subject image T4 sent to the image correction portion 23 is subjected to: a luminance correction such as a shading correction; a distortion correction; and a magnification correction (Step S6). The subject image T4 after correction is outputted to the image position displacement calculation portion 25.

Furthermore, in the image position displacement calculation portion 25, the subject model regions (search model patterns, or alignment marks) Ta to Tc that are most similar to at least the three respective model regions Ra to Rc are extracted from the subject pattern T5 displayed in the subject image T4. The amount of rotational difference and displacement of the center position of the subject pattern T5 with respect to the OF T1 of the semiconductor wafer T as the reference position are acquired based on the respective center coordinates of these reference model regions Ra to Rc and those of the subject model regions Ta to Tc, and are stored in the data storage portion 37 (Step S7).

Then, in the defect extraction portion 27, the subject image T4 or the semiconductor wafer T is rotated and moved to perform the second positioning so that the position of the subject pattern T5 captured by the imaging portion 17 is matched with the position of the reference pattern R5 based on the amount of rotational displacement and the center positional displacement. Subsequently, each of the pixels of the reference pattern R5 are compared with each of the corresponding pixels of the subject pattern T5, and a defect position of the subject pattern T5 is extracted (Step S8). Subsequently, in the pass-or-fail determination portion 29, a pass-or-fail determination of the semiconductor wafer T is made based on the defect information data (Step S9). The macro inspection result is then displayed on the display portion 35 and stored in the data storage portion 37 (Step S10).

Finally, after the defect inspection, the semiconductor wafer T is transferred from the specimen holding portion 13 to the cassette by the specimen transfer portion (Step S11). After completion of the defect inspection of all the semiconductor wafers T, the cassette is unloaded by the cassette loading and unloading portion 7 to the outside of the macro inspection apparatus 1 (Step S12).

After this, every time a new layer is formed on the same semiconductor wafer T, loaded into the macro inspection apparatus 1, defect inspection of the subject pattern T5, and unloading from the macro inspection apparatus 1 are sequentially repeated as described above. Furthermore, the loading to the macro inspection apparatus 1, the defect inspection of the subject pattern T5, and the unloading from the macro inspection apparatus 1 are also sequentially repeated on a plurality of semiconductor wafers T.

As described above, according to this macro inspection apparatus 1, even if the alignment mark and the subject pattern T5 are exposed in the first exposure step when the semiconductor wafer T is mounted while being displaced from the reference position of the specimen holding portion, it is possible to acquire, at the same time of the macro inspection, the rotational displacement and center positional displacement between the formation position of the subject pattern T5 and that of the reference pattern R5 that is formed in the correct position. The position of the semiconductor wafer T or the subject image T4 is corrected by rotation and movement based on this calculated displacement amount, so that the subject pattern T5 can be positioned quickly and easily. In this manner, the coordinates of the defect and the coordinates of the alignment mark are offset with respect to the reference coordinates on the specimen holding portion 13 based on the displacement amount of the subject pattern T5, so that the coordinates of each defect can be precisely identified and the alignment mark can quickly be detected.

Moreover, because the displacement amount between the subject pattern T5 and the reference pattern R5 can be calculated on a pixel basis of the images T4 and R4, it is possible to calculate a highly accurate displacement amount, and to accurately perform positioning of the subject pattern T5 based on the displacement amount.

Furthermore, the data storage portion 37 is provided for storing the displacement amount data. Therefore, various apparatuses other than the macro inspection apparatus 1, such as an inspection apparatus which handles the semiconductor wafer T and a manufacturing apparatus, read the displacement amount data from the data storage portion 37 and utilize it. Thereby, it is also possible to perform positioning of the subject pattern T5 with ease in the various apparatuses.

Furthermore, in the defect extraction portion 27, the position of the reference pattern R5 and that of the subject pattern T5 are aligned based on the displacement amount. Therefore, local shapes of the reference pattern R5 and the subject pattern T5 are precisely compared, so that a defect position of the subject pattern T5 with reference to the shape of the reference pattern R5 can be detected with a high degree of precision.

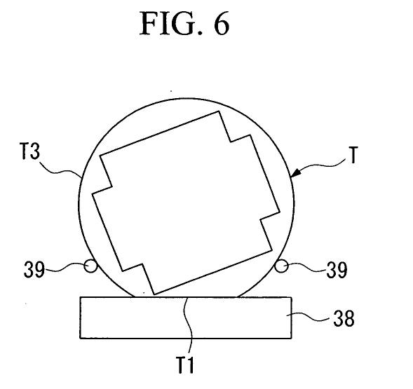

In the above-mentioned embodiment, alignment of the rotational position and the central position are performed in the specimen alignment portion 9. However, the invention is not limited thereto. Only the alignment of the rotational position may be performed. However, in the case of this construction, it is necessary for the specimen alignment portion 9 to be provided with outer circumference holding portions 38 and 39 for abutting the OF T1 and the curve portion T3 which form the outer circumferential sections of the semiconductor wafer T as shown in, for example, FIG. 6.

Furthermore, the linear OF has been described as being formed in the semiconductor wafer T. However, the invention is not limited thereto. For example, a cutout-shaped notch may be formed on the outer circumference thereof. In addition, in the specimen alignment portion 9, positioning of the semiconductor wafer T in the rotational position may be performed based on the position of the notch.

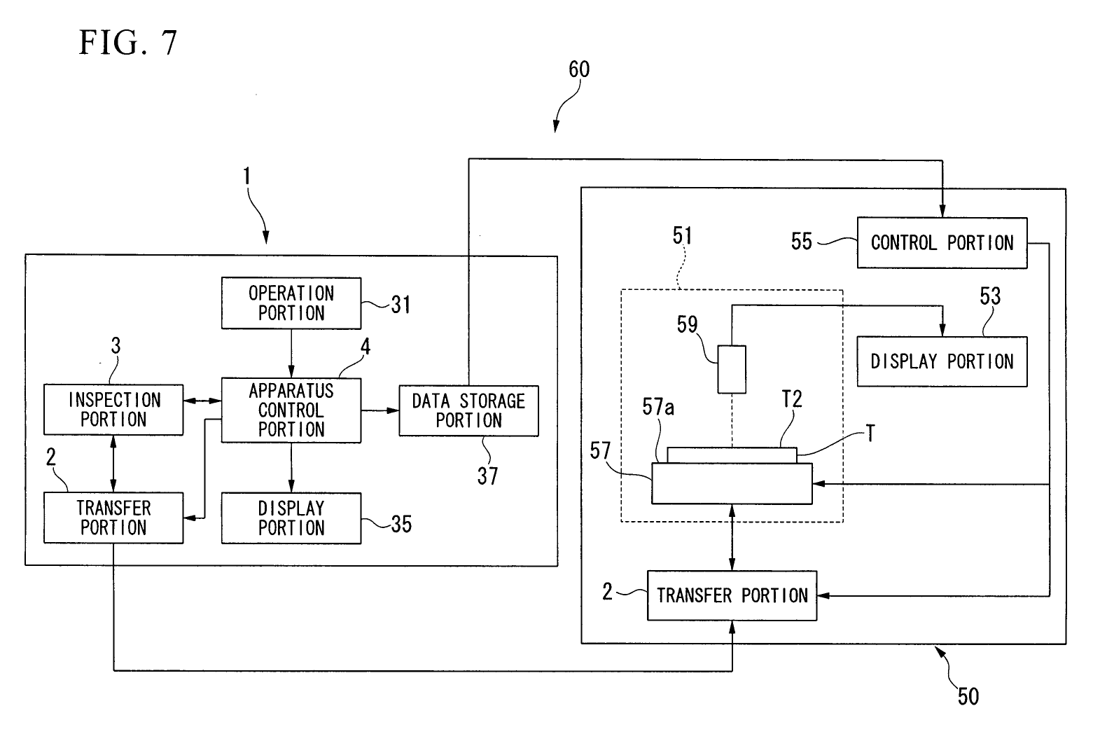

Furthermore, the displacement amount that is acquired in the image position displacement calculation portion 25 has been described as being utilized for calculating a defect position of the subject pattern T5 in the macro inspection apparatus 1. However, the invention is not limited thereto. The displacement amount may be utilized in an apparatus for positioning the subject pattern T5. That is, for example, as shown in FIG. 7, the displacement amount may be utilized in a micro inspection apparatus 50 that magnifies a defect position for visual recognition of detailed analysis of the circuit pattern defect.

This micro inspection apparatus 50 includes a transfer portion 2, a magnification inspection portion 51, a display portion 53, and a control portion 55. This transfer portion 2 is similar to one mounted in the macro inspection apparatus 1.

The magnification inspection portion 51 includes a specimen holding portion 57 and an imaging portion 59. Similarly to the specimen holding portion 13 of the macro inspection apparatus 1, the specimen holding portion 57 is configured so as to hold a semiconductor wafer T by suction-clamping so that the semiconductor wafer T is mounted on an upper surface 57a thereof. Moreover, this specimen holding portion 57 is movable in two directions along an upper surface 57a thereof. The imaging portion 59 obtains a magnified image of a defect position of the subject pattern T5 that is detected in the macro inspection apparatus 1. This magnified image is displayed on the display portion 53.

A control portion 55 controls various drive portions of the transfer portion 2 and controls the movement of the specimen holding portion 57. That is, when taking in magnified image from the subject pattern T5, the control portion 55 reads data on the reference image R4, including data on the defect position and displacement amount, from the data storage portion 37 of the macro inspection apparatus 1. The control portion 55 then modifies the detection range of a defect position (a predetermined region) based on the defect position data and the displacement amount data, and controls the movement of the specimen holding portion 57 so that the defect position of the subject pattern T5 is in the image captured range of the imaging portion 59, and thereby align the semiconductor wafer T. In this micro inspection apparatus 50, a defect inspection is made by visually recognizing a defect displayed in magnification on the display portion 53 in the manner as described above.

These macro inspection apparatus 1 and the micro inspection apparatus 50 constitute a pattern inspection system 60 for inspecting a defect of the subject pattern T5.

According to this pattern inspection system 60, it is possible to quickly and easily detect a position of defect in the subject pattern T5 by utilizing the displacement amount data in the micro inspection apparatus 50. Therefore, it is possible to quickly and reliably perform a defect inspection of the subject pattern T5.

An apparatus for positioning the subject pattern T5, for example a semiconductor wafer manufacturing apparatus (an exposure apparatus) that sequentially laminates a plurality of layers on a semiconductor wafer T, may be used instead of the above-mentioned micro inspection apparatus 50. Also in the case where a displacement amount is utilized in this semiconductor wafer manufacturing apparatus, it is possible to quickly and easily position the subject pattern T5. Therefore, when a new pattern is formed over the subject pattern T5 in a superimposing manner, it is possible to position these two patterns.

Furthermore, the subject pattern T5 and the reference pattern R5 have been described as circuit patterns. However, the invention is not limited thereto. For example, the pattern may be an alignment mark. Consequently, also in the case where the formation position of an alignment mark is automatically detected, it is possible to modify a detection range of an alignment mark based on this displacement amount. Therefore, it is possible to quickly and easily position and detect an alignment mark.

The calculation of the displacement amount has been described as being performed in the macro inspection apparatus 1. However, the invention is not limited thereto. It may suffice that at least a displacement amount can be calculated. Therefore, calculation of a displacement amount may be performed in an apparatus which is the macro inspection apparatus 1 without the defect extraction portion 27 for extracting a defect and the pass-or-fail determination portion 29.

Embodiments of this invention have been described in detail above with reference made to the drawings. However, specific structures of this invention are not limited to these embodiments, and include various design modifications and the like without departing from the spirit or scope of this invention.

According to the pattern alignment method and the pattern inspection apparatus of the present invention, the position of the subject specimen is corrected based on a displacement amount between the subject pattern and the reference pattern formed in the correct position, and thereby it is possible to quickly and easily position the subject pattern. Furthermore, according to the image capturing device and the image measuring device of the present invention, it is possible to measure the displacement amount between the subject pattern and the reference pattern pixel by pixel, and hence it is possible to calculate a highly accurate displacement amount. Therefore, it is possible to align the subject pattern based on the displacement amount with a high level of accuracy. Furthermore, when the pattern inspection apparatus of the present invention is provided with a storage device, various other apparatuses that handle the subject specimen read the data of the displacement amount from the storage device and use it. Thereby it is possible to easily align the subject pattern in the various apparatuses. Furthermore, according to the comparison device of the present invention, the position of the reference pattern and that of the subject pattern are aligned. Therefore, it is possible to precisely and easily make close range comparisons of the subject pattern to the reference pattern to precisely grasp the defect position of the subject pattern with reference to the shape of the reference pattern. Furthermore, according to the pattern inspection system of the present invention, by using a displacement amount of the formation position of the subject pattern in the micro inspection apparatus, it is possible to easily detect a predetermined region of the subject pattern with a defect in a short time, and to quickly and reliably make a defect inspection of the subject pattern.

1. A pattern inspection apparatus, comprising:
a specimen alignment device that places a plate-shaped subject specimen in a position in which the shapes of outer circumferential sections of the subject specimen are substantially aligned with the shapes of outer circumferential sections of a plate-shaped reference specimen, the shapes of the reference specimen being similar to the shapes of the subject specimen; and
a displacement amount calculation device that calculates the displacement amount between the position of a subject pattern formed on the subject specimen and the position of a reference pattern formed on the reference specimen while the shapes of the outer circumferential sections of the subject specimen are aligned with the shapes of the outer circumferential sections of the reference specimen.

2. The pattern inspection apparatus according to claim 1, wherein the displacement amount calculation device comprises:
an image capturing device that captures a reference image of the reference specimen and a subject image of the subject specimen; and
an image measurement device that calculates the displacement amount based on positional information of the reference pattern and the subject pattern in the reference image and the subject image.

3. The pattern inspection apparatus according to claim 1, further comprising:
a storage device that stores the displacement amount.

4. The pattern inspection apparatus according to claim 1, wherein the displacement amount is made of:
a rotational displacement amount that is an angular difference between a formation direction of the reference pattern and a formation direction of the subject pattern; and
a center positional displacement amount that is a difference between a center position of a formation region of the reference pattern and a center position of a formation region of the subject pattern.

5. The pattern inspection apparatus according to claim 1, further comprising:
a comparison device that makes a correction by aligning the position of the subject pattern with the position of the reference pattern and also compares the shapes of the subject pattern with the shapes of the reference pattern.

6. The pattern inspection apparatus according to claim 5, wherein
the comparison device comprises a defect extraction device which, when a difference in the characteristic distance between a predetermined region of the subject pattern and a relevant region of the reference pattern corresponding to the predetermined region is larger than a predetermined threshold value, extracts the predetermined region as a defect.

7. A pattern inspection system comprising:
the pattern inspection apparatus according to claim 6; and
a micro inspection apparatus which modifies a detection range of the predetermined region based on the displacement amount and magnifies the predetermined region for visual recognition of the defect.

8. A pattern alignment method comprising:
placing a plate-shaped subject specimen in a position in which shapes of outer circumferential sections of the subject specimen are aligned with shapes of outer circumferential sections of a plate-shaped reference specimen relative to each other, the shapes of the reference specimen being similar to the shapes of the subject specimen; and
a displacement amount calculation step of calculating a displacement amount between the position of a subject pattern formed on the subject specimen and the position of a reference pattern formed on the reference specimen while the shapes of the outer circumferential sections of the subject specimen are respectively aligned with the shapes of the outer circumferential sections of the reference specimen.

9. The pattern inspection apparatus according to claim 2, further comprising:
a storage device that stores the displacement amount.
